(19) United States
(12) Patent Application Publication
(10) Pub. No.: US 2004/0035281 A1
(43) Pub. Date: Feb. 26, 2004

(54) Electroplated diamond blade

(76) Inventor: Ron Gaynor, Boca Raton, FL (US)

Correspondence Address: Robert M. Downey, ROBERT M. DOWNEY, P.A., Suite 350, 150 E. Palmetto Park Road, Boca Raton, FL, 33432, US

(21) Appl. No.: 10/606,913

(22) Filed: Jun. 26, 2003

Related U.S. Application Data
(60) Provisional application No. 60/392,080, filed on Jun. 27, 2002.

(51) Int. Cl. B26D 1/12; B26B 9/00

(52) U.S. Cl. 83/835; 83/666; 30/350

(57) ABSTRACT

A disc-shaped blade used in a power tool includes opposite side faces and an outer circumferential zone having radially aligned, equally spaced notches extending outwardly from gullets to define arcuate blade segments spaced about the outer periphery of the disc-shaped body. A first composite mixture containing diamond particles of a first mesh size is electroplated to an outermost peripheral edge of each of the blade segments to provide a cutting edge. In one embodiment, a second composite mixture containing diamond particles of a second mesh size is electroplated to the opposite side faces of the blade for beveling cut ends of PVC and ductile iron pipe.

### BACKGROUND OF THE INVENTION

1. Field of the Invention

The present invention relates generally to circular saw blades and, more particularly, to a circular saw blade having an outer segmented rim which is electroplated with abrasive diamond particles to provide equally spaced arcuate cutting edge segments about the outer circumference of the blade and, an abrasive surface on opposite side faces of the blade for beveling cut pipe.

2. Discussion of the Related Art

Circular saw blades are used in many fields for cutting different types of material including wood, metal, concrete, PVC and the like. Of particular relevance to the present invention is the need to cut ductile iron pipe and PVC pipe as well as metal studs used for framing walls during construction.

Presently, ductile iron and PVC pipe are cut with the use of abrasive blades in power cutting tools. Typically, circular abrasive blades are 12′ or 14′ in diameter and consist of a central layer formed of aluminum oxide and silicon carbide resins, and reinforced fiberglass mats on each side to hold the core layer together. When used to cut PVC pipe, abrasive blades are generally effective and have good longevity. However, when abrasive blades are used for cutting ductile iron pipe, the cutting longevity drops drastically. Specifically, the cutting life of an abrasive blade used in cutting ductile iron pipe is approximately 7 to 9 minutes of cutting time before the blade needs to be replaced. Replacement of the blade requires approximately 6 to 8 minutes of labor. Thus, when using abrasive blades to cut ductile iron pipe, thirteen hours of cutting time will require approximately 100 blades and approximately 700 minutes (over 10 hours) of labor. Depending upon the geographical area of the country, the cost of the labor required for changing 100 blades may range between $275 to over $500. Furthermore, cutting ductile iron pipe with the use of abrasive blades presents serious safety concerns. In addition to unsafe flexing and possible disintegration of abrasive blades when cutting ductile iron pipe, the matting of the blade wears fairly quickly and, once this happens, the blade will come apart in chunks, putting anyone in the surrounding area at serious risk of injury.

Once ductile iron pipe or PVC pipe has been cut, the cut edge needs to be beveled. The proper and safe way to bevel the cut pipe involves the use of a hand grinder powered by a generator or air compressor located on the job site. Because this beveling operation is labor intensive and can be extremely expensive, particularly in union locations, many contractors, against recommendations of blade manufacturers, use the sides of the abrasive blade to bevel the pipe. However, because abrasive blades often flex during the beveling application, and sometimes break apart, this practice presents yet a further danger to anyone working near the beveling operation.

### OBJECTS AND ADVANTAGES OF THE INVENTION

It is a primary object of the present invention to provide a blade for use in an electric power tool or gas powered high-speed saw for cutting and beveling ductile iron pipe and PVC pipe.

It is a further object of the present invention to provide a blade for use in an electric power tool or gas powered high-speed saw for cutting and beveling ductile iron pipe and PVC pipe and which provides a significantly larger number of cuts per blade (i.e. longer useful life) than conventional abrasive blades.

It is still a further object of the present invention to provide a blade for use in an electric power tool for cutting metal studs used for framing walls during construction.

It is still a further object of the present invention to provide a blade for use in an electric power tool or gas powered high-speed saw for cutting and beveling ductile iron pipe and PVC pipe while providing a significantly reduced cost per cut when compared to conventional abrasive blades used for the same purpose.

It is still a further object of the present invention to provide an improved blade for use in an electric power tool or gas powered high-speed saw for cutting and beveling ductile iron pipe and PVC pipe, as well as metal studs, and wherein the blade significantly reduces labor costs.

It is still a further object of the present invention to provide a segmented and electroplated diamond blade which is specifically designed for use in cutting and beveling ductile iron pipe and PVC pipe, as well as metal studs, and wherein the blade is specifically structured to resist cracking, fracture, and potentially harmful disintegration during use.

It is still a further object of the present invention to provide a blade for use in an electric power tool or gas powered high-speed saw for cutting and beveling ductile iron pipe and PVC pipe at a faster rate then conventional abrasive blades.

It is still a further object of the present invention to provide a blade for use in an electric power tool or gas powered high-speed saw for cutting and beveling ductile iron pipe and PVC pipe and which will last the life of at least 100 conventional blades.

It is still a further object of the present invention to provide a blade for use in an electric power tool or gas powered high-speed saw for cutting and beveling ductile iron pipe and PVC pipe and wherein the labor saved by not having to change the blade as often as conventional abrasive blades results in savings which account for at least 50% of the cost of the blade.

It is still a further object of the present invention to provide a blade for cutting and beveling ductile iron pipe and PVC pipe, as well as metal studs, and wherein the blade eliminates the dangerous carcinogens produced from abrasive blades, while providing a much cleaner working environment.

It is still a further object of the present invention to provide a blade for cutting and beveling ductile iron pipe and PVC pipe and wherein the blade is not affected by water on maintenance projects (e.g. broken mains in cities).

These and other objects and advantages of the present invention are more readily apparent with reference to the following detailed description.

### SUMMARY OF THE INVENTION

The present invention is directed to a disc-shaped blade for use in a power tool. The blade includes opposite side faces and an outer circumferential zone having radially aligned, equally spaced notches extending outwardly from gullets to define arcuate blade segments spaced about the outer periphery of the disc-shaped body. A first composite mixture containing diamond particles of a first mesh size is electroplated to an outermost peripheral edge of each of the blade segments to provide a cutting edge. In one embodiment, a second composite mixture containing diamond particles of a second mesh size is electroplated to the opposite side faces of the blade for beveling cut ends of PVC and ductile iron pipe.

### BRIEF DESCRIPTION OF THE DRAWINGS

For a fuller understanding of the nature of the present invention, reference should be made to the following detailed description taken in conjunction with the accompanying drawings in which:

FIG. 1 is a top plan view of the segmented electroplated diamond blade of the present invention;

FIG. 2 is a cross-sectional view of the segmented electroplated diamond blade taken along the line 2-2 in FIG. 1; and

FIG. 3 is a top plan view of an alternative embodiment of the segmented electroplated diamond blade of the present invention which is particularly suited for cutting metal studs.

Like reference numerals refer to like parts throughout the several views of the drawings.

### DETAILED DESCRIPTION OF THE PREFERRED EMBODIMENT

Referring to the drawings, the electroplated diamond blade of the present invention is shown and is generally indicated as 10. The diamond blade 10 includes a disk-shaped body 12 including a core 14 formed of a substantially hard material, such as hardened steel. The core 14 is surrounded by an outer circumferential zone 16 having a plurality of notches 18 extending radially towards the center of the blade body 12. The notches 18 are equally spaced about the outer circumferential zone to define a plurality of arcuate blade segments 20 of equal length about the outer periphery of the blade body 12. The notches extend radially inward from the blade edge and terminate at circular gullets 24.

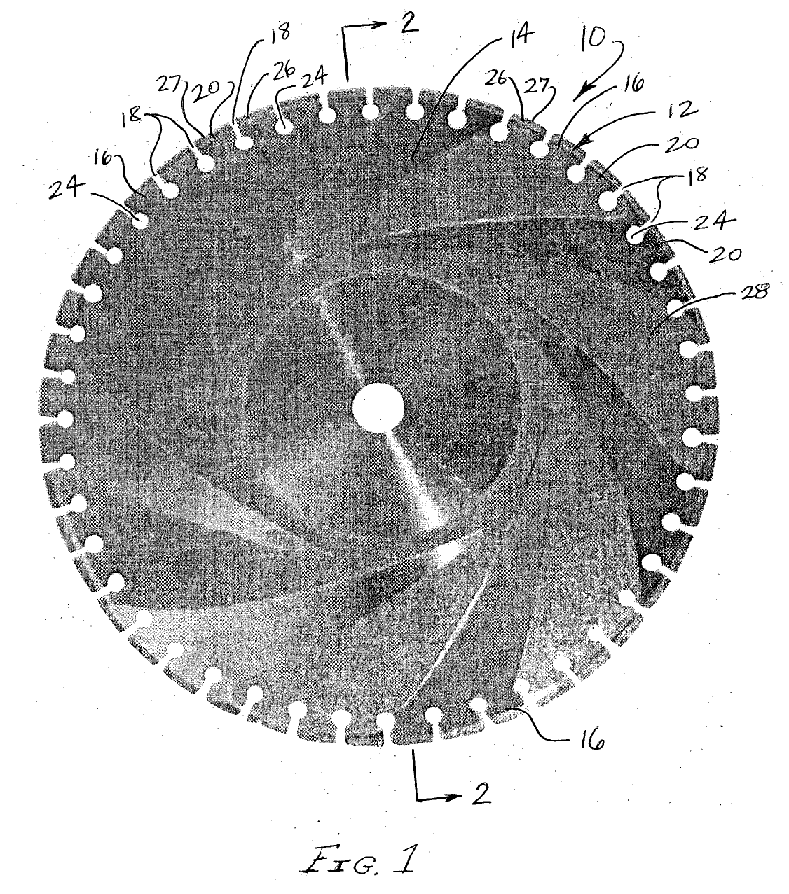

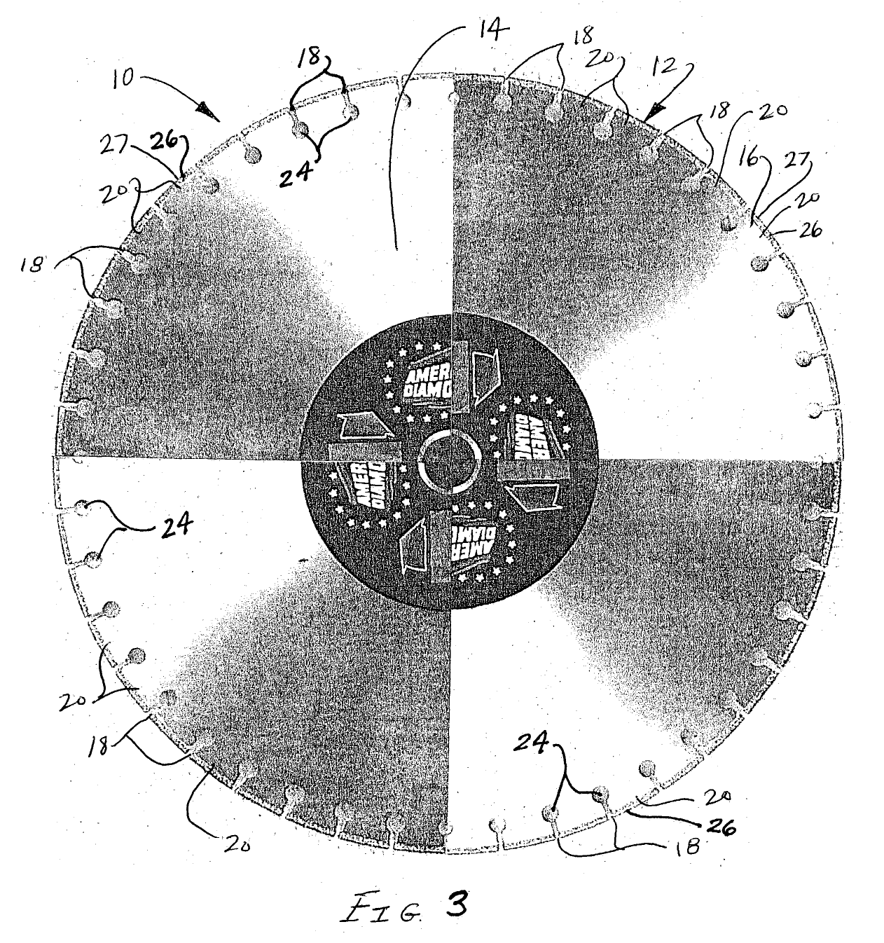

In each of the embodiments shown in FIGS. 1-3, a first composite mixture 26 containing diamond particles is electroplated to the blade segments, to form a hardened, long-lasting cutting edge 27. In a preferred embodiment, the diamond particles are disbursed throughout the composite mixture in accordance with a predetermined mesh size of between 40-50 mesh. In order to reduce vibration and heat, it has been determined that the optimal segment length of each of the blade segments is between 2.0 cm and 3.0 cm. The short segment length of the blade segments reduces excessive heat and vibration. Additionally, short segment lengths provide additional gullets which further reduces heat and the occurrence of cracks in the blade body 12.

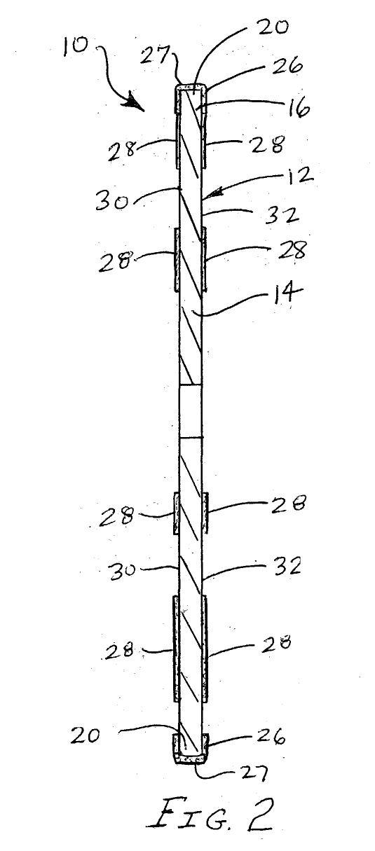

In a preferred embodiment of the present invention, as shown in FIGS. 1 and 2, a second composite mixture 28 containing diamond particles is electroplated to the opposite side faces 30, 32 of the blade body 12. More specifically, the diamond particles in the second composite mixture are disbursed throughout the mixture in accordance with a predetermined mesh size of between 55-65 mesh diamond grit. As seen in FIG. 1, the second composite mixture is preferably applied to the opposite side faces 30, 32 of the blade body in a pattern which may be radially flared in a direction opposite to the rotation of the blade to reduce excessive vibration and heat build up. The second composite diamond grit mixture on the opposite side faces of the blade is used to bevel the cut ends of ductile iron pipe and PVC pipe by contacting the side facing the blade against the cut edge of the pipe while maintaining the blade at an angle of approximately 45 degrees relative to the longitudinal axis of the pipe.

While the instant invention has been shown and described in accordance with a preferred and practical embodiment thereof, it is recognized that departures from the instant disclosure are contemplated within the spirit and scope of the present invention.

What is claimed is:

1. A blade for a power tool, said blade comprising:
a disc-shaped body having opposite side faces and an outer circumferential zone with an outermost periphery;
a plurality of arcuate blade segments spaced about said outermost periphery of said disc-shaped body, said arcuate blade segments being defined between equally spaced notches extending radially outward from circular gullets formed through said outer circumferential zone; and
a first composite mixture containing diamond particles of a first mesh size electroplated to said outermost periphery along said plurality of arcuate blade segments to define a cutting edge.

2. The blade as recited in claim 1 further comprising a second composite mixture containing diamond particles of a second mesh size electroplated to at least one of said opposite side faces of said disc-shaped body.

3. The blade as recited in claim 2 wherein said second composite mixture is electroplated to both of said opposite side faces of said disc-shaped body.

4. The blade as recited in claim 1 wherein a length of each of said plurality of arcuate blade segments, measured along said outermost periphery between said notches, ranges between 2.0 centimeters and 3.0 centimeters.

5. The blade as recited in claim 1 wherein said first mesh size of said first composite mixture ranges between 40 and 50 mesh diamond grit.

6. The blade as recited in claim 1 wherein said second mesh size of said second composite mixture ranges between 55 and 65 mesh diamond grit.

7. A blade for a power tool, said blade comprising:
a disc-shaped body having opposite side faces and an outer circumferential zone with an outermost periphery;
a plurality arcuate blade segments spaced about said outermost periphery of said disc-shaped body, said arcuate blade segments being defined between equally spaced notches extending radially outward from circular gullets formed through said outer circumferential zone;
a first composite mixture containing diamond particles of a first mesh size electroplated to said outermost periphery along said plurality of arcuate blade segments to define a cutting edge; and
a second composite mixture containing diamond particles of a second mesh size electroplated to at least one of said opposite side faces of said disc-shaped body.

8. The blade as recited in claim 7 wherein said second composite mixture is electroplated to both of said opposite side faces of said disc-shaped body.

9. The blade as recited in claim 7 wherein a length of each of said plurality of arcuate blade segments, measured along said outermost periphery between said notches, ranges between 2.0 centimeters and 3.0 centimeters.
